(19) United States
(12) Patent Application Publication
(10) Pub. No.: US 2026/0054551 A1
(43) Pub. Date: Feb. 26, 2026

(54) Motor Vehicle With a Shade and/or Visibility Protection Device on a Hatchback With a Rear Window

(71) Applicant: BAYERISCHE MOTOREN WERKE AKTIENGESELLSCHAFT, München (DE)

(72) Inventor: Markus VOSS, Muenchen (DE)

(21) Appl. No.: 19/103,280

(22) PCT Filed: Aug. 9, 2023
(86) PCT No.: PCT/EP2023/072039

§ 371 Date: Feb. 12, 2025

(30) Foreign Application Priority Data
Sep. 7, 2022 (DE) 10 2022 122 667.0

(51) Int. Cl. B60J 1/20

(52) U.S. Cl. CPC B60J 1/208; B60J 1/2052

(57) ABSTRACT

A motor vehicle has a shade and/or visibility protection device for a rear window and a rear flap. The rearflap is pivotally attached or secured to a body of the motor vehicle. The shade and/or visibility protection device has a shade and/or visibility protection element which is arranged, mounted, or secured to the rear flap in a movable manner with respect to the rear window. A lateral guide is provided for the shade and/or visibility protection element, the lateral guide being arranged on the body, i.e. a non-pivotal body part in contrast to the rear flap. The lateral guide is used to laterally support the shade and/or visibility protection element when the element is being moved or is in a use position so as to partly or completely cover the rear window.

### BACKGROUND AND SUMMARY

The invention relates to a motor vehicle, in particular a passenger vehicle, for example, having a steep rear hatch with a shade on a rear flap having a rear window.

A known passenger vehicle having a notchback, which is also referred to as limousine, has a shading device in the form of a roller blind, a blind, or the like on a rear window. In this instance, the roller blind is accommodated in a parcel shelf and is mechanically or electrically deployed as required in order to reduce sun radiation or to protect visibility.

A passenger vehicle having a steep rear hatch is also known and has a rear flap with an integrated rear window. The rear flap can be pivoted upward in order to open. In this instance, a rear roller blind which is accommodated substantially completely in a rear flap trim is also known.

An object of the present invention is to provide a shade and/or visibility protection device on a rear flap having a rear window, wherein a construction for opening and closing the shade is improved.

This object is achieved with a motor vehicle which has the combination of features of the independent claim(s). Advantageous further developments are set out in the dependent claims.

According to the invention, a motor vehicle has a shading and/or visibility protection device for a rear window and a rear flap. The rear flap has the rear window. The rear flap is pivotably fitted or secured to a body of the motor vehicle. The shading and/or visibility protection device has a shading and/or visibility protection element which is displaceably arranged or supported or secured on the rear flap with respect to the rear window. Furthermore, according to the invention, a lateral guide is provided for the shading and/or visibility protection device, which is arranged on the body, that is to say, a body component which in contrast to the rear flap is not pivotable. The lateral guide serves to laterally support the shading and/or visibility element when it is displaced or when it is in a position for use completely or partially covering the rear window.

The arrangement of the lateral guide of the shading and/or visibility protection element on the body-instead of on the rear flap-saves structural space in the rear flap, and the rear flap can be configured to be lighter. This is advantageous for opening and closing the rear flap and for load absorption of rear flap hinges.

The motor vehicle is preferably a passenger vehicle, in particular with a fastback or steep rear hatch, for example, of the wagon or SUV (Sports Utility vehicle) or off-road vehicle type. The rear flap preferably opens about an upper axis which extends parallel with a transverse vehicle direction (y direction in the vehicle coordinate system) in an upward direction. The rear flap could, however, also be laterally pivotable.

In particular, the shading and/or visibility protection element can be displaced and/or moved back and forth between a position of non-use, that is to say, in a position in which the shading and/or visibility protection element is not effective as a shading or visibility protection, and one or more positions for use. In the position of use, the shading and/or visibility protection element is partially or completely effective as a shading or visibility protection of the rear window, thus it covers the rear window partially or completely on the vehicle interior side of the rear window. In the position of non-use, the shading and/or visibility protection element does not cover the rear window.

The term “shading” is intended to be understood to be a sun protection or darkening for the interior. The term “visibility protection” is in particular intended to be understood to be a limited visibility from the exterior into the interior. In both cases, this is particularly advantageous when there is located in the vehicle interior of the motor vehicle, that is to say, a passenger compartment, a screen which where applicable is fitted to a vehicle roof inner side (for example, for a rear seat row) and which can be used for vehicle passengers. Consequently, on the one hand, direct sun radiation on the screen through the rear window is prevented or at least reduced and the vehicle interior can be sufficiently darkened so that the vehicle passenger can see content on the screen and, on the other hand, for the driver or other passengers of a subsequent vehicle visibility into the vehicle interior, for example, onto the screen, is limited so that, for example, the driver of the following vehicle is not distracted by the screen content.

The shading and/or visibility protection element for the rear window may be formed by a rollable web. Such a shading and/or visibility protection element is also referred to as a roller blind.

The shading and/or visibility protection element for the rear window may be formed by a foldable web. Such a shading and/or visibility protection element is also referred to as a folding blind or pleated blind or pleated curtain.

The rollable or foldable web may be formed by a textile material or a film. The rollable or foldable web may be configured to be partially transparent or non-transparent.

The shading and/or visibility protection element for the rear window may also be formed by a web or a surface element which can be displaced in a planar form between a position of non-use and a position of use. In this instance, the shading and/or visibility protection element may also be configured to be slightly stiffer (since it is not rolled or folded) up to being completely inherently rigid.

The shading and/or visibility protection element for the rear window may also be formed by a large number of shutter slats. Such a shading and/or visibility protection element is also referred to as a shutter, wherein the shutter slats are formed as inherently rigid individual elements which can, where applicable, be pivoted about a longitudinal axis.

According to a preferred exemplary embodiment, the lateral guide has a drive for displacing (opening and closing) the shading and/or visibility protection element.

By accommodating the drive in the lateral guide, the rear flap can be configured to be lighter and less structural space is required in the rear flap.

The drive may be an electric drive.

Alternatively, the drive may also be carried out manually.

Preferably, the shading and/or visibility protection element may be displaceably arranged from below or from above relative to the rear window and be secured or supported on the rear flap at that location. In other words, the shading and/or visibility protection element is arranged in the position of non-use completely above the rear window on the rear flap or completely below the rear window on the rear flap. In this instance, the shading and/or visibility protection element may in particular be integrated in a rear flap trim so that it is substantially invisible in the position of non-use.

Preferably, the lateral guide is formed at a left side and a right side of the body.

The lateral guide may be arranged on a rearmost body pillar depending on the body shape, in particular on a C-pillar or D-pillar of the body. The lateral guide is in this instance in particular integrated in a body pillar trim.

The lateral guide preferably forms a slotted member in which the shading and/or visibility protection element engages and in which the shading and/or visibility protection element is guided when it is moved from the position of non-use to the position of use.

The lateral guide may have a carrier which, when the rear flap is closed, is configured for engagement with the shading and/or visibility protection element. The shading and/or visibility protection element can be moved or displaced with the carrier.

The shading and/or visibility protection element has a transverse bow which can also be referred to as a push or/and pull bow. One end portion or both end portions, that is to say, the left and right end portion of the transverse bow, engage in the lateral guide or with a carrier of the lateral guide.

The transverse bow may have in the longitudinal extent thereof a variable length in order to compensate for a non-constant spacing between the shading and/or visibility protection element and the lateral guide in a guiding direction of the lateral guide (a displacement direction between the position for use and position for non-use).

Generally, the body does not taper in the transverse direction (y direction in the vehicle coordinate system) over a vehicle height to the same extent as the rear window. In this instance, the transverse bow with a changeable length is advantageous.

According to another preferred further development, the engagement between the shading and/or visibility protection element, for example, the transverse bow, and the lateral guide is carried out when the rear flap is being closed.

Alternatively, the engagement between the shading and/or visibility protection element, for example, the transverse bow, and the lateral side is carried out with a drive of the carrier only when the rear flap is already closed.

According to another preferred further development, before the rear flap is opened, the shading and/or visibility protection element can automatically be displaced into a position of non-use and can be moved out of engagement with the lateral guide. That is to say, when a user gives a rear flap opening instruction, for example, via a rear flap handle or a remote control or a gesture operation or voice operation or the like, before the rear flap is opened, a position of the shading and/or visibility protection element is first detected. If the shading and/or visibility protection element is not in the position of non-use, that is to say, a position in which the shading and/or visibility protection element is stored, for example, in a rear flap trin, the shading and/or visibility protection element is first displaced into the position of non-use. If the shading and/or visibility protection element in the position of non-use is still in engagement with the lateral guide, the engagement with the lateral guide is released. Only when the shading and/or visibility protection element is in the position of non-use and is out of engagement with the lateral guide is the rear flap opening instruction carried out. Alternatively, the shading and/or visibility protection element may also have a specific, extendable excess length so that it is not necessary to move the shading and/or visibility protection element out of engagement with the lateral guide before the rear flap is opened.

To this end, a separate control device may be provided, or the control is integrated in an existing rear flap control or the like. Furthermore, position detection sensors for a position detection of the shading and/or visibility protection element are provided to this end. The drive of the shading and/or visibility protection element may be synchronized either electrically or mechanically.

The features mentioned above may as far as possible and advantageous be freely combined with each other.

### BRIEF DESCRIPTION OF THE DRAWINGS

FIG. 1 is a schematic, perspective view of a rear portion of a motor vehicle with an open rear flap according to an exemplary embodiment of the present invention.

FIG. 2 is a schematic, perspective view of the rear portion of the motor vehicle with a closed rear flap and open shading and/or visibility protection device according to the exemplary embodiment of the present invention.

FIG. 3 is a schematic, perspective view of the rear portion of the motor vehicle with a closed rear flap and closed shading and/or visibility protection device according to the exemplary embodiment of the present invention.

FIG. 4 is a schematic sectioned view along the line B-B in FIG. 5, that is to say, in a vertical vehicle direction and a transverse vehicle direction, an engagement of a carrier of the shading and/or visibility protection device with an end portion of a shading bow according to the exemplary embodiment of the present invention.

FIG. 5 is a schematic sectioned view along the line A-A in FIG. 4, that is to say, in the vertical vehicle direction and a longitudinal vehicle direction, of the engagement of the carrier of the shading and/or visibility protection device with the end portion of the shading bow according to the exemplary embodiment of the present invention.

### DETAILED DESCRIPTION OF THE DRAWINGS

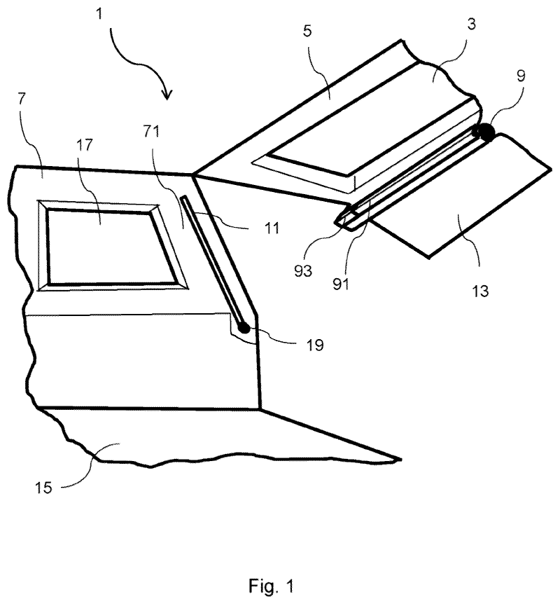

With reference to FIGS. 1 to 5, an exemplary embodiment of the present invention is described below.

As shown in FIG. 1, a passenger vehicle having a steep rear hatch according to the exemplary embodiment of the present invention includes a rear flap 5 having a rear window 3 in an upper region of the rear flap 5. The rear flap 5 can be pivoted upward by means of hinges which are not illustrated about a transverse vehicle axis relative to a body 7. In FIG. 1, only a portion of a luggage compartment 15 and a lateral rear window 17 and a D-column 71 of the body is shown. The rear flap 5 is located in FIG. 1 in an open state.

On the rear flap 5, below the rear window 3 a roller blind 9 which forms a shading and/or visibility protection element according to the invention is secured. In FIG. 1, the roller blind 9 is in a position of non-use and is consequently completely rolled up. The roller blind 9 is stored behind a rear flap trim 13. The roller blind 9 acts as a sun or glare protection for vehicle passengers and visibility protection from outside the vehicle through the rear window 3 into the passenger vehicle. In the D-pillar 71 shown, a lateral guide 11 for the roller blind is arranged within a D-pillar trim. The lateral guide 11 extends along the D-pillar 71 in an upward direction. In the other D-pillar not shown in FIG. 1, a lateral guide 11 is also accommodated in a similar manner. A driven carrier 19, in FIG. 1 in the lowest position thereof, is arranged in the lateral guide II so as to be able to be displaced along the lateral guide 11.

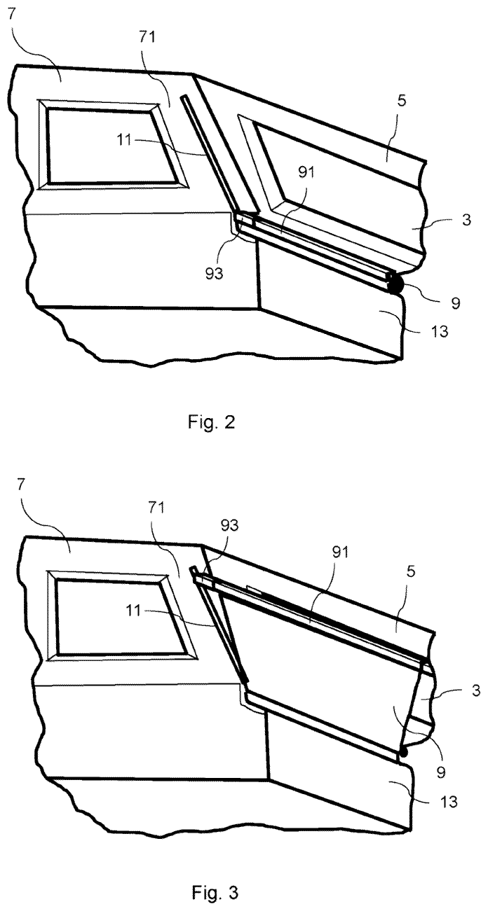

In FIG. 2, the passenger vehicle is shown with a closed rear flap 5, wherein the roller blind 9 is opened, that is to say, is in a completely rolled-up position, and via a transverse bow 91 which is fitted to the upper end of a textile roller web of the roller blind 9, can be brought into engagement with the lateral guides 11. The roller blind 9 is in a position of non-use and the view through the rear window 3 is clear.

In FIG. 3, the motor vehicle is shown with a closed rear flap 5, wherein the roller blind 9 is closed, that is to say, the roller blind 9 is in an unrolled state and completely covers the rear window 3. The roller blind 9 is accordingly in a position for use. The transverse bow 91 is displaced as far as an upper end of the lateral guides 11.

The roller blind web of the roller blind 9 limits in this position for use any view through the rear window 3 in accordance with a degree of transparency of the roller blind web of the roller blind 9. The roller blind web of the roller blind 9 is pulled out of the rear flap trim 13 via a corresponding slot in the rear flap trim 13.

In one of the lateral guides 11 or in both lateral guides 11, an electric drive for displacing, that is to say, for opening and closing, the roller blind 9 is accommodated.

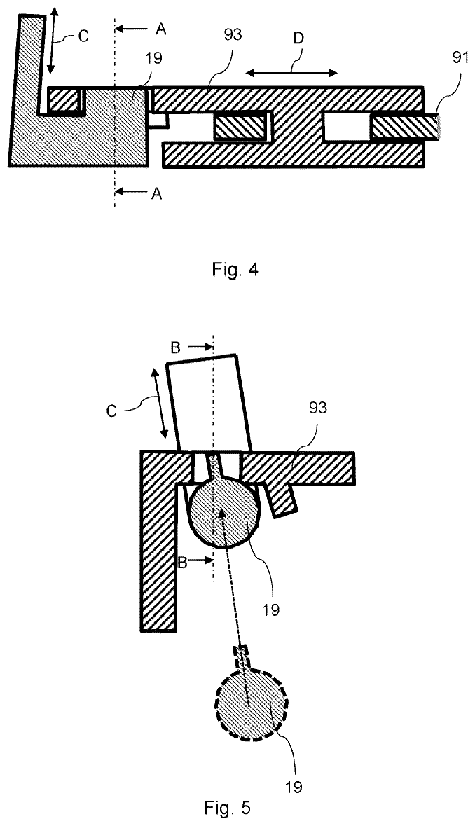

The drive has, for example, the carrier 19 which is shown in greater detail in FIGS. 4 and 5 and which can be displaced within the lateral guide 11 along the longitudinal extent, that is to say, in the direction of the arrow C, of the lateral guide 11. The carrier 19 is configured for engagement with an end portion 93 of the transverse bow 91. The end portion 93 is displaceably supported so as to be able to be moved in the transverse direction, that is to say, in the direction of the arrow D, on the transverse bow 91 in order to compensate for a different spacing between the lateral guides 11 in the transverse vehicle direction over the vehicle height. The spacing between the lateral guides 11 becomes increasingly small in the vertical vehicle direction in this passenger vehicle. Accordingly, the end portion 93 moves in FIG. 4 to the right as the roller blind web of the roller blind 9 is increasingly rolled out with respect to the transverse bow 91.

In FIG. 5, a position of the carrier 19 is shown with a broken line, wherein the carrier 19 is out of engagement with the transverse bow 91. In this position of the carrier 19, the rear flap 5 can be opened and closed. In this position of the carrier 19, the roller blind 9 is further in the position of non-use thereof, that is to say, completely rolled up. In the position of the carrier 19, with a solid line, the carrier 19 is in engagement with the end portion 93 of the transverse bow.

The passenger vehicle further has a control unit for the roller blind 9. When a user opens the rear flap 5, the roller blind 9 is first automatically displaced into the completely open position by means of the electric drive and moved out of engagement with the lateral guide 11. Only afterwards is the rear flap 5 opened. To this end, sensors for position detection of the roller blind 9 are provided. If the roller blind 9 is not in the position of non-use thereof, the roller blind 9 is first displaced into the position of non-use. If the roller blind 9 is already in the position of non-use but not in engagement with the carrier 93, the engagement with the carrier 93 is released. Only when the roller blind 9 is in the position of non-use and out of engagement with the carrier 93 is the rear flap opening instruction carried out. Alternatively, the roller blind web of the roller blind 9 has an excess length so that, when the roller blind web of the roller blind 9 is in the position of use and the rear flap 5 is opened, the roller blind web of the roller blind 9 is rolled out further according to a pivoting action of the rear flap 5 counter to a resilient pretensioning of a winding shaft of the roller blind 9. Or the roller blind web of the roller blind 9 is accordingly configured to be inherently resilient so that it is resiliently expanded accordingly when the rear flap 5 is opened.

In the closed state of the rear flap 5, the user can displace the roller blind 9 as required into the position desired by the user by means of corresponding operation.

If the passenger vehicle has a screen which is fitted to the vehicle roof at the interior, the roller blind 9 is automatically moved into the closed position as soon as the screen is operated so that screen content cannot be seen or can only be seen to a limited extent by occupants of following vehicles.

1.-10. (canceled)

11. A motor vehicle, comprising:
a shading and/or visibility protection device for a rear window and a rear flap containing the rear window, the rear flap being pivotably secured to a body of the motor vehicle, wherein
the shading and/or visibility protection device comprises a shading and/or visibility protection element which is displaceably arranged on the rear flap with respect to the rear window, and a lateral guide provided for the shading and/or visibility protection element, the lateral guide being arranged on the body.

12. The motor vehicle according to claim 11, wherein
the shading and/or visibility protection element for the rear window is a rollable web, a foldable web, a large number of shutter slats, or a displaceable plate element.

13. The motor vehicle according to claim 11, wherein
the lateral guide comprises a drive for displacing the shading and/or visibility protection element, wherein the drive is an electric drive.

14. The motor vehicle according to claim 11, wherein
the shading and/or visibility protection element is displaceable from below or from above relative to the rear window, and is secured at that location to the rear flap.

15. The motor vehicle according to claim 14, wherein the shading and/or visibility protection element is integrated in a rear flap trim.

16. The motor vehicle according to claim 11, wherein the lateral guide is formed at both a left side and a right side of the body.

17. The motor vehicle according to claim 11, wherein
the lateral guide is arranged on a rearmost body pillar and is integrated in a body pillar trim.

18. The motor vehicle according to claim 11, wherein
the lateral guide has a carrier which, when the rear flap is closed, is configured for engagement with the shading and/or visibility protection element.

19. The motor vehicle according to claim 18, wherein the engagement is with a transverse bow on the shading and/or visibility protection element.

20. The motor vehicle according to claim 19, wherein
the transverse bow has a variable length in order to compensate for a non-constant spacing between the shading and/or visibility protection element and the lateral guide in a guiding direction.

21. The motor vehicle according to claim 18, wherein
the engagement is carried out when the rear flap is being closed, or
the engagement is carried out by a drive of the carrier only when the rear flap is closed.

22. The motor vehicle according to claim 11, wherein, before the rear flap is opened, the shading and/or visibility protection element is automatically displaceable into a position of non-use and is movable out of engagement with the lateral guide.
